(19) United States
(12) Patent Application Publication
(10) Pub. No.: US 2010/0308127 A1
(43) Pub. Date: Dec. 9, 2010

(54) Process and apparatus for applying pest control particulate in a confined area

(76) Inventor: William Leon Walker, JR., Abingdon, MD (US)

Correspondence Address: JOHN E. SIMMS JR., 6803 YORK ROAD, SUITE 202, BALTIMORE, MD, 21212, US

(21) Appl. No.: 12/806,476

(22) Filed: Aug. 13, 2010

Related U.S. Application Data
(63) Continuation of application No. 12/082,893, filed on Apr. 15, 2008.
(60) Provisional application No. 60/961,241, filed on Jul. 19, 2007.

(51) Int. Cl. B05D 1/10; B65D 37/00

(52) U.S. Cl. 239/8; 222/206

(57) ABSTRACT

A process and apparatus for applying pest control particulates. The apparatus of the present invention comprises a duster including a bulb reservoir, charged with pest control particulate, and having an orifice closed by a releasably attachable cap. The cap is provided with an outlet communicating with a flexible conduit having a distal end with a rigid plastic tube. The distal end may be held stationary and trained on a target area while the bulb reservoir may be alternately reoriented, as the bulb is compressed, for controlled application of the pest control particulate. The invention also includes a vacuum cleaner operating in blower mode and blower hose assembly having a coupling port. The vacuum cleaner may be operated to induce a high speed air flow and the flexible conduit of the duster may be connected to the coupling port for entraining pest control particulate into the high speed air flow for greater range dispensing of the pest control particulate.

### CROSS REFERENCE TO OTHER APPLICATIONS

This is a continuation of application Ser. No. 12/082,893, Filed 15 Apr. 2008, now abandoned, which application claimed the benefit of Provisional Patent Application No. 60/961,241, filed 19 Jul. 2007.

### BACKGROUND

Pests pose a significant health risk to humans in home and work environments. Pests take advantage of opportunities to find food, water, and nesting sites in close proximity to humans and humans frequently come into contact with pests or substances deposited by the pests. Exposure to such pests and substances can cause disease. Elimination of pest infestations is an important factor in maintaining an optimum level of public health. The plentiful supply of food and water sources associated with areas of human habitation contribute to rapid reproduction in the pest population, making it impractical to treat a pest infestation by trapping the pests. It is conventional practice to treat pest infestations, particularly of the insect or rodent variety, by poisoning the pests.

Poisoning is typically accomplished by placing a pesticide in an area where the pests are likely to encounter it. The pesticide is combined with bait to encourage the pest to ingest the pesticide. It is common practice to place the bait in a box located in an area frequented by pests. The box is provided with an opening for entry and exit. Unfortunately, non-targeted species may also enter and ingest the bait with pesticide. Dogs, cats, and other non-targeted species may reach the material inside the box. Desirable species of birds have been poisoned from eating insects, which have ingested pesticide from a bait box, as well.

Alternatively, the pesticide, commonly called tracking powder, is spread where pests will contact the chemical and ingest it while grooming. Tracking powder not safe for humans, pets and other non-targeted species. Great care must be taken to spread pesticide in controlled quantities and in specifically targeted areas. Tracking powder and other pesticides are most conveniently applied in particulate form. There is a particular danger for children and pets because pesticides spread on baseboards, in cabinets and other low traffic areas for humans, may be visited by children and pets. Outdoor applications of pesticide must also be completed with care to avoid depositing pesticide in an area accessible to humans or pets.

In order to reduce the likelihood of human contact with pesticides apparatuses have been developed to apply the pesticide to a preselected target area, such as wall voids and under cement slabs where there is, under normal circumstances, no chance of contact with humans or non-target species. The typical prior art apparatus for applying particulate pesticide consists of a rubber bulb reservoir having a single orifice. The reservoir is charged with pesticide. The orifice is closed by a cap having an outlet communicating with a rigid tube extending from the cap to a distal end. The distal end of the rigid tube typically narrows to form a nozzle for dispersing the pesticide. The apparatus may be manually operated by repeatedly squeezing the bulb to pneumatically propel pesticide outward through the nozzle. A homeowner or pest treatment professional may apply pesticide in a building by drilling a series of holes through wallboard and cabinet backing. The rigid tube, of the apparatus, may be inserted through the drilled hole and the bulb may be squeezed to propel the pesticide into a wall void or space behind a cabinet. This method works to deposit pesticide to areas of the building frequented by pests but generally out of reach of humans or pets.

The bulb reservoir may be operated effectively to deliver a desired amount of particulate by orienting the bulb to a preselected attitude before squeezing. When the bulb is oriented in an upright attitude, with the orifice at the top, gravity will cause the supply of particulate to rest at the base of the bulb opposite the orifice. Squeezing the bulb will propel a relatively light dusting of particulate outward through the orifice. When the bulb is oriented in an inverted attitude, with the orifice at the bottom, the supply of particulate will rest adjacent to the orifice. Squeezing the bulb will propel a relatively dense measure of particulate outward through the orifice. If the tube becomes impacted with particulate, the bulb may be squeezed while in upright orientation to clear the tube. It is an advantage to have the capability of reorienting the bulb, while the nozzle is inserted in a drilled hole. By reorienting the bulb reservoir, the operator may control the quantity of pesticide disbursed into a particular target area. Once the rigid tube of the prior art apparatus is inserted into a hole, the attitude of the bulb cannot be changed, so the quantity of pesticide cannot be controlled. Certain pesticides are effectively applied as a light dusting. Other pesticides, such as tracking powder, are best applied as a relatively thick layer, in a high traffic area. The range for dispersion of the particulate is relatively limited because of the capacity of the hand held bulb. It is necessary to drill a large number of relatively closely spaced holes in order to thoroughly cover a wall void or other space.

There is a need for a manually operated apparatus for broadcasting pest control particulate which allows for reorientation of a bulb with respect to an orifice while a nozzle remains stationary. There is a need for an apparatus for applying pest control particulate having an improved range of dispersion. There is a need for a process of applying pest control particulate which provides control over the quantity and density of pesticide applied. There is a need for a process for applying pesticide with an improved range.

### SUMMARY

It is an object of the present invention to provide a manually operated apparatus, for applying pest control particulate, having a bulb reservoir which may be reoriented while a nozzle means remains stationary. It is an object of the present invention to provide an apparatus for applying pest control particulate in inaccessible areas. It is another object of the present invention to provide a process for applying pest control particulate which provides control over the quantity and density of pesticide applied. It is yet another object of the present invention to provide a process for applying pesticide with an improved range.

The present invention is an improved process for application of pest control particulate and an improved apparatus for applying pest control particulate. The apparatus includes a duster having a pneumatic dispersion means charged with pest control particulate, preferably a bulb reservoir having an inside space. The reservoir has an orifice communicating with the inside space and is manually operable, by squeezing the bulb, to cause pneumatic dispersion of particulate outward through the orifice. A cap is provided for covering the orifice. The cap is provided with an outlet communicating with the inside space. The duster also includes a flexible conduit having a distal end and a proximal end. The flexible conduit is connected to the cap with the proximal end in communication with the outlet. The distal end is fitted with rigid nozzle means for directing the outflow of particulate. The nozzle means may be trained toward a preselected target area and the reservoir may be simultaneously oriented to a preselected attitude. The reservoir may be oriented in upright fashion, with the reservoir below the orifice, for disbursing a light dusting of particulate or the reservoir may be oriented in inverted fashion, with the reservoir above the orifice, for disbursing a heavy measure of particulate. The reservoir may be thus reoriented while the nozzle means remains stationary.

The present invention further includes blower means and a blower hose assembly. The blower hose assembly has a proximal end and a distal end. The proximal end is operably connected to the blower means for producing a high speed air flow through the blower hose assembly. The blower hose assembly includes a coupling port which communicates with the air flow within the blower hose assembly. The distal end of the flexible conduit may be connected in communication with the coupling port. The blower means may be operated to produce a high speed air flow within the blower hose assembly and the bulb may be operated to entrain particulate in the air flow, in controlled quantities. A hose extension may be connected to the blower hose assembly and partially inserted in an otherwise inaccessible area, for propelling pest control particulate outward through the distal end of the blower hose assembly, through the hose extension and into an inaccessible area.

### BRIEF DESCRIPTION OF THE DRAWINGS

The present invention may be further understood with reference to the appended drawings in which:

FIG. 1A is a perspective view of the duster of the present invention.

FIG. 1B is a perspective view of an alternate nozzle means on the distal end of a flexible conduit.

FIG. 2 is a perspective view of the bulb reservoir of the present invention with the cap removed and pest control particulate being added.

FIG. 3 is a disassembled view of the duster of the present invention and a rigid extension tube.

FIG. 4A is a perspective view of an individual operating the duster of the present invention with the bulb reservoir in an upright orientation.

FIG. 4B is a perspective view of an individual operating the duster of the present invention with the bulb reservoir in an inverted orientation.

FIG. 5A is a perspective view of the blower means and blower hose assembly of the present invention.

FIG. 5B is an inset view taken from FIG. 5A showing detail of the coupling port.

FIG. 6 is a perspective view of the blower means and blower hose assembly, of the present invention, with the duster, of the present invention connected.

FIG. 7A a perspective view of a tail piece with a coupling port.

FIG. 7B is a perspective view of a tail piece with an alternate coupling port including a valve.

FIG. 7C is a perspective view of a tail piece with no coupling port.

FIG. 8 is a perspective view of a blower hose and a duster connected to an alternate coupling port.

FIG. 9 is a cut-away view of an animal burrow with the apparatus of the present invention fitted and positioned for applying pest control particulate to the burrow.

FIG. 10 is a cut-away view of a void below a concrete slab with the apparatus of the present invention fitted and positioned for applying pest control particulate into the void.

### DETAILED DESCRIPTION OF THE PREFERRED EMBODIMENT

The present invention relates generally to apparatuses and processes for distributing pest control particulate and more particularly to an apparatus including a duster, which may be manually operated to achieve a controlled application of pest control particulate directly to a target area and to a blower means and blower hose assembly, which may be operated in conjunction with the duster to entrain controlled quantities of pest control particulate into an air flow in the blower hose assembly. The present invention includes the process of applying pest control particulate directly from the duster and the process of greater range application of pest control particulate in conjunction with the blower means and blower hose assembly, for blowing a flow of air with entrained pest control particulate to a target area.

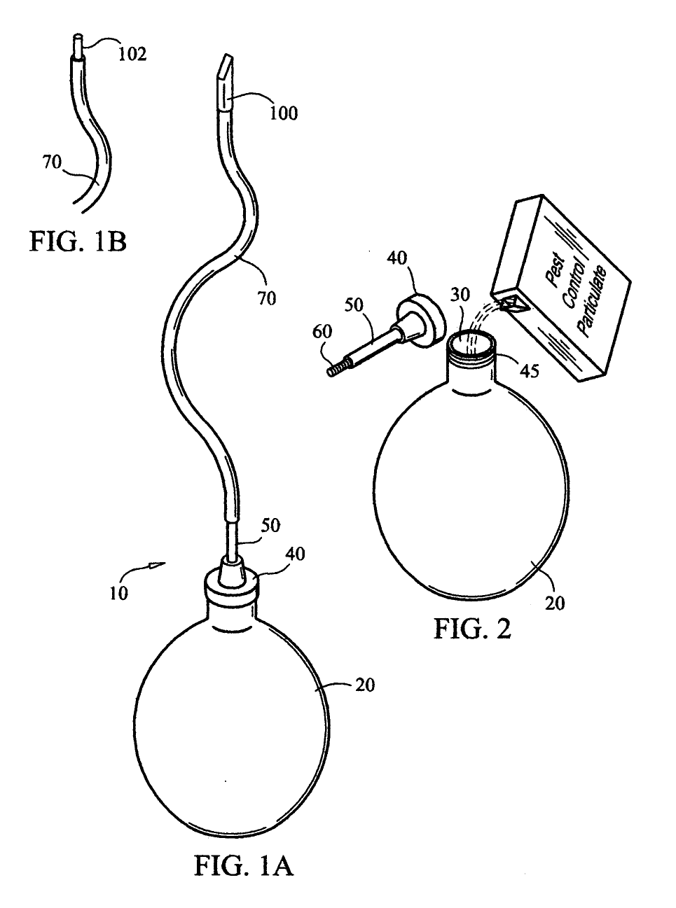

The duster 10 of the present invention is shown in FIG. 1A and includes manually operable pneumatic dispersion means such as a bulb reservoir 20 preferably formed of flexible and resilient material. It is also preferred that the bulb reservoir 20 be formed of liquid impervious material. Natural rubber is a suitable material but flexible and resilient plastics will also serve. The bulb reservoir 20 is formed with a generally rounded shape sized to fit comfortably in the hand of an individual and defines an inside space. The bulb reservoir 20 is provided with an orifice 30 communicating with the inside space, as shown in FIG. 2. A cap 40 is configured to cover the orifice 30 and is provided with means for releasable attachment. Such releasable attachment means are preferably a threaded portion on the outer aspect of the bulb reservoir 20 proximate to the orifice 30 and mating threads on an inner aspect of the cap 40. It is preferred that the cap 40 be formed of metal and that a threaded metal collar 45, as shown in FIG. 2, surround and define the orifice 30 and be designed to mate with and retain the cap 40. Other conventional releasable attachment means are also suitable. It is preferred that the cap 40 have an outlet communicating with the inside space and an outward tubular extension 50 with a threaded distal end 60. The threaded distal end 60 defines the opening to the tubular extension 50 which communicates, through the outlet, with the inside space when the cap 40 is attached. It is preferred that the orifice 30 have an inside diameter of approximately one and one quarter to one and one half inches (1¼ to 1½), to facilitate the deposit of pest control particulate and that tubular extension 50 have an inside diameter of approximately one quarter to three eighths inches (¼ to ⅜), for disbursing pest control particulate. The tubular extension 50 is preferably formed of brass.

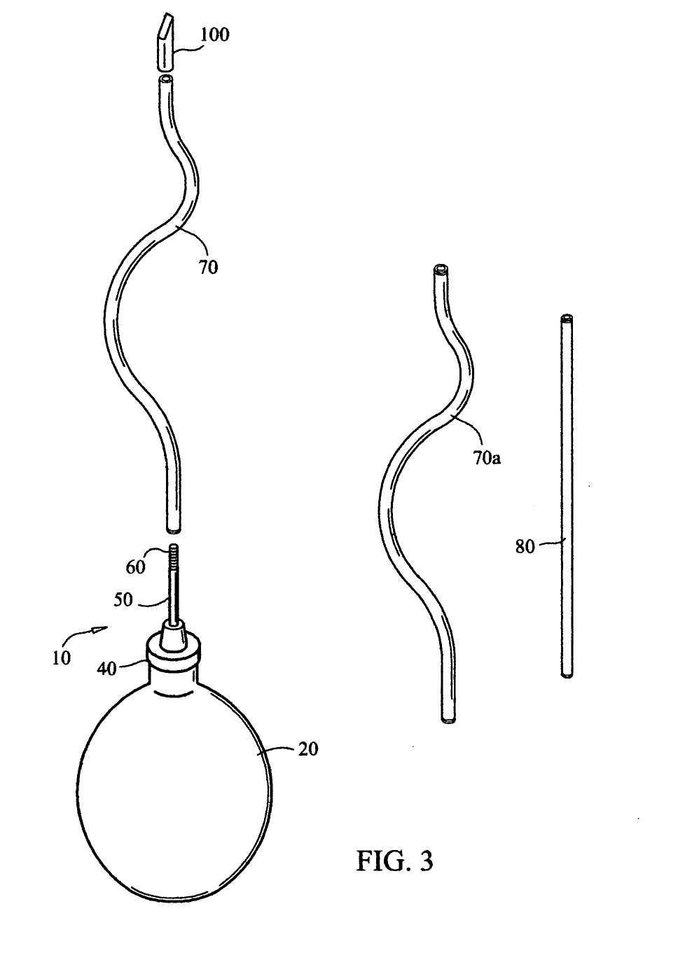

The duster 10 also includes a flexible conduit 70 preferably formed of a length of plastic tubing, as shown in FIGS. 1A, 1B, and 3. Transparent tubing having a one quarter inch (¼) diameter is preferable. The flexible conduit 70 has a proximal end and a distal end. The proximal end is provided with means for releasable attachment to the tubular extension 50. A nut, preferably formed of brass, may be inserted into the proximal end to frictionally engage the inside surface of the flexible conduit 70 and lie generally flush with the proximal end. The nut is configured to mate with the threaded distal end 60 of the tubular extension 50 for releasable attachment of the flexible conduit 70 in communication with the tubular extension 50. Alternatively, the proximal end of the flexible conduit 70 may be sized to partially receive the tubular extension 50 in close fitting frictional engagement, eliminating the need for the nut and the threaded distal end 60. Rigid nozzle means are provided for releasable attachment to the distal end of the flexible conduit 70. Nozzle means preferably comprise a selection of conventional miniature vacuum cleaner attachments, which may be partially inserted and frictionally engaged inside the distal end of the flexible conduit 70. FIG. 1A shows a conventional crevice tool attachment 100. FIG. 1B shows a portion of the flexible conduit 70 with a rigid plastic pipe 102 inserted into the distal end of the flexible conduit 70. It is to be understood that a variety of miniature vacuum cleaner attachments and rigid pipes having a curved shape, would be useful with the present invention. A miniature vacuum cleaner attachment or other nozzle means may be inserted into the distal end of the flexible conduit 70, and retained by frictional engagement with the inside surface, of the flexible conduit 70. Conventional miniature vacuum cleaner attachments and a plastic pipe 102 are typically formed of plastic and are safe for use in areas where the nozzle means may contact electric wiring. Where no electrical elements are nearby, brass nozzle means may be used.

FIG. 3 shows a rigid extension tube 80, for extending the reach of the apparatus. The proximal end of the flexible conduit 70 may receive the tubular extension 50, in close fitting frictional engagement and the distal end of the flexible conduit 70 may receive and frictionally engage the rigid extension tube 80. The end of the rigid extension tube 80 opposite the connection point for the flexible conduit 70 may be straight or bent at the convenience of the user and also may be provided with nozzle means of various conventional design to produce a desired pattern for disbursing the particulate. Additional rigid tubes similar to the rigid extension tube 80 may be connected in series to further extend the reach of the apparatus.

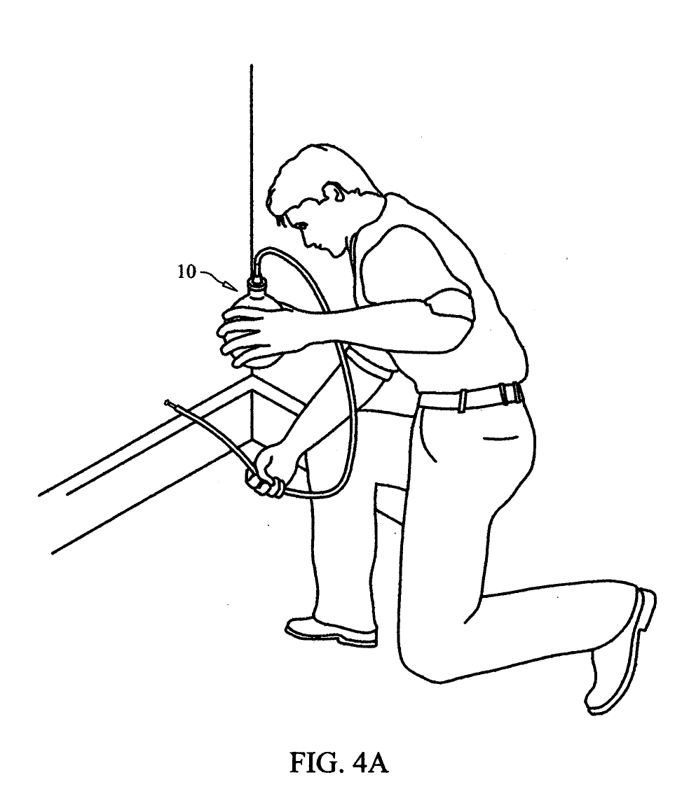

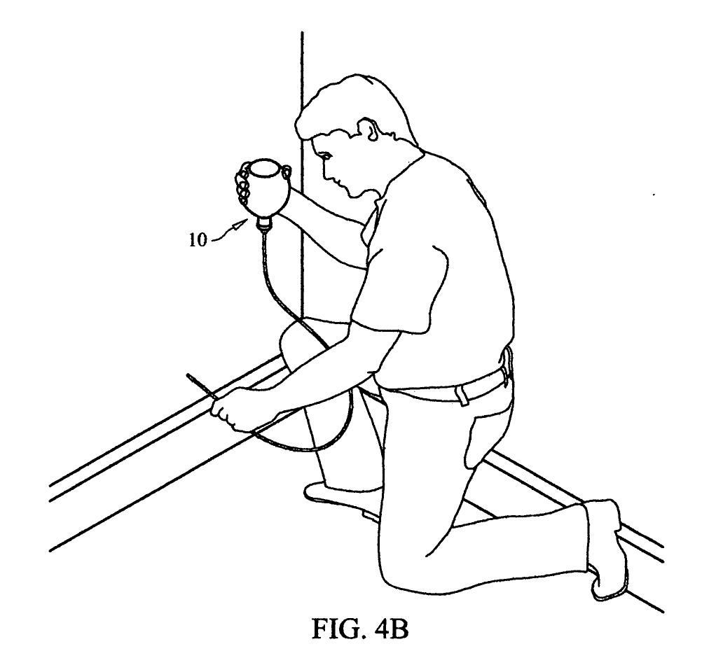

The charging of the bulb reservoir 20 is depicted in FIG. 2. After charging the bulb reservoir 20 with pest control particulate and replacing the cap 40, the duster 10 may be used to apply pest control particulate. An exemplary use is depicted in FIG. 4A. The flexible conduit 70 is attached to the tubular extension 50. The distal end, preferably including nozzle means for directing the flow of particulate, such as the crevice tool attachment 100, or plastic pipe 102 is trained on a target area for depositing the pest control particulate. This may require that the crevice tool attachment 100, or plastic pipe 102, be inserted into a hole drilled in an interior building wall, as shown in FIG. 4A. The bulb reservoir 20 is operated in upright orientation, as shown in FIG. 4A, such that the portion of the inside space adjacent to the orifice 30 is occupied by air. Squeezing the bulb reservoir 20 will increase the air pressure in the inside space, fetch up a quantity of pest control particulate and carry a dusting of particulate outward through the flexible conduit 70 and into the wall void. In order to increase the density of particulate application, the bulb reservoir 20 may be operated in inverted orientation, as shown in FIG. 4B. In inverted orientation, the space adjacent to the orifice 30 is occupied by pest control particulate. Squeezing the bulb reservoir 20 urges a portion of the pest control particulate outward through the orifice 30 and into the flexible conduit 70. The individual may repeatedly squeeze the bulb reservoir 20 to move a particularly desired measured quantity of particulate into the flexible conduit 70. The bulb reservoir 20 may then be repositioned to upright orientation, as shown in FIG. 4A, and squeezed to deliver the measured quantity of particulate to the target area. For measuring the quantity of particulate, it is preferred that the flexible plastic conduit 70 be graduated with visible markings. It will be appreciated by those skilled in the art that the flexible conduit 70 allows for repositioning of the bulb reservoir 20 while the distal end and crevice tool attachment 100, or plastic pipe 102, remains stationary and trained on the target area.

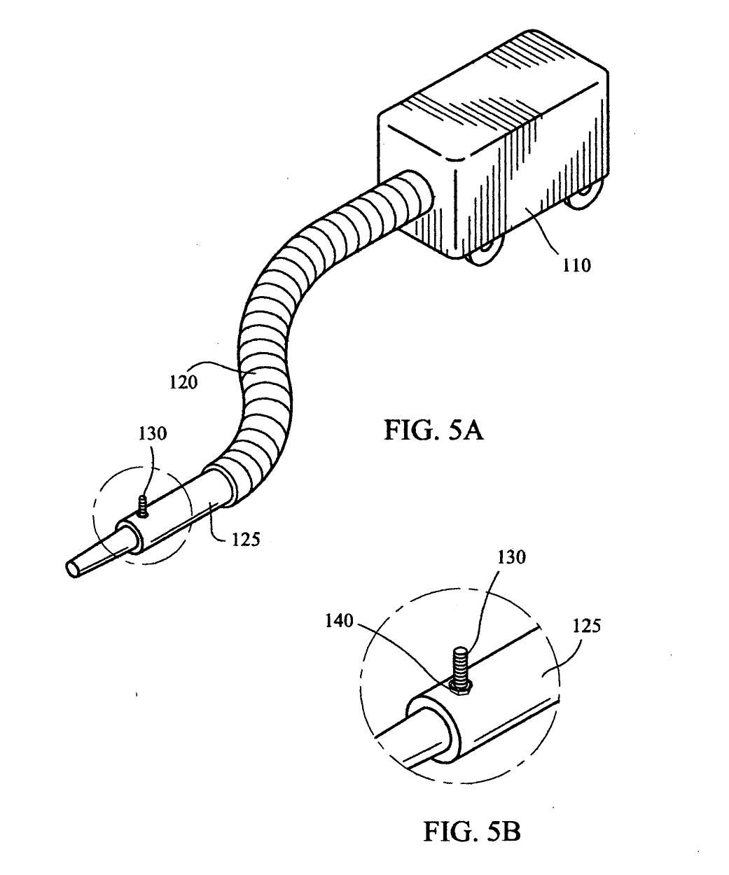

The present invention further includes a blower means and a blower hose assembly. The blower means is preferably a portable electric vacuum cleaner 110. The blower hose assembly preferably includes a vacuum cleaner hose 120 and an interchangeable tail piece It is to be understood that the vacuum cleaner hose 120 has an proximal end and a distal end. The proximal end is attached to the vacuum cleaner 110 and configured, in a conventional manner for operation as a blower. The distal end is configured for receiving the interchangeable tail piece such as a discharge tube 125, shown in FIG. 5A, for forming an air conduit directing a flow of air from the vacuum cleaner 110 outward through the discharge tube 125. The discharge tube 125 includes a coupling port 130. The coupling port 130 appears in FIG. 5A and may be seen in greater detail in the inset FIG. 5B. The coupling port 130 preferably consists of a rigid tube having a threaded outside surface. An intermediate portion of the tube is mounted in a hole provided in the surface of the discharge tube 125, such that a first end of the tube extends transversely outward from the discharge tube 125 and a second end of the tube communicates with the air flow provided by the vacuum cleaner 110 inside the blower hose assembly. The coupling port 130 may be fixed on the discharge tube 125 by advancing a nut from each end of the threaded tube to contact the discharge tube 125 and confine the threaded tube in fixed position. An outer nut 140 is threaded onto the first end of the threaded tube and an inner nut (not shown) is threaded onto the second end of the threaded tube. Other conventional means for fixing the coupling port 130, are also suitable.

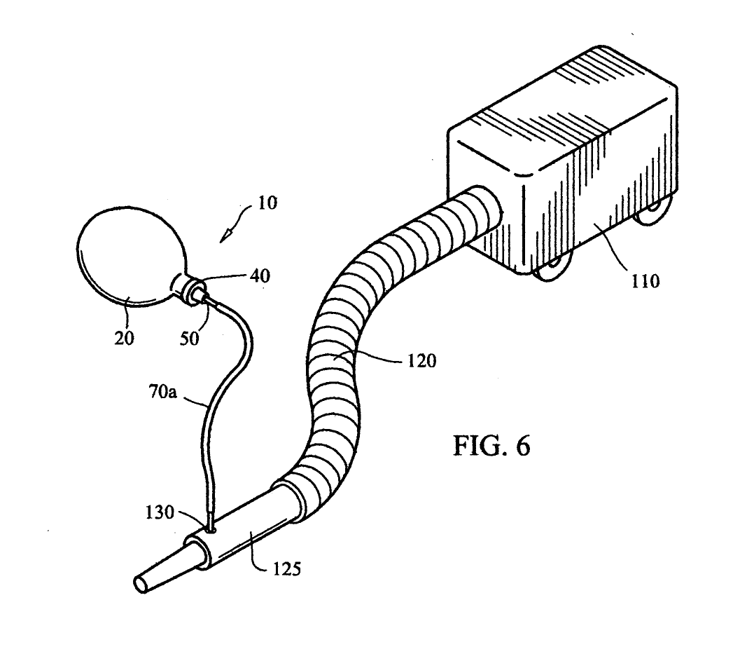

In use, the proximal end of the flexible conduit 70, may be connected to the tubular extension 50, of the duster 10, and the distal end of the flexible conduit 70 may be connected to the coupling port 130 by coupling means. It is preferred that the threaded tube forming the coupling port 130 be selected to be partially received within and frictionally engage the distal end of the flexible conduit 70. A nut, which is confined in frictional engagement in the distal end of the flexible conduit 70, may also conveniently serve as the coupling means. While the vacuum cleaner 110 is operated in the blower mode, the bulb reservoir may be squeezed to introduce a quantity of particulate to the air flow inside the vacuum cleaner hose 120, to entrain the particulate with the air flow, as shown in FIG. 6. It will be appreciated that the discharge tube 125 may be trained on a target area for the application of pesticide particulate. It will also be appreciated that the vacuum cleaner hose 120 may be augmented with conventional extender attachments and tail pieces of conventional design to reach inaccessible areas, penetrate narrow openings or extend the reach of the device. It is to be further appreciated that the technique of alternately reorienting the bulb reservoir 20 in upright and inverted orientations to control the quantity of particulate being entrained in the air flow in a given time period may be effectively used in conjunction with the blower means.

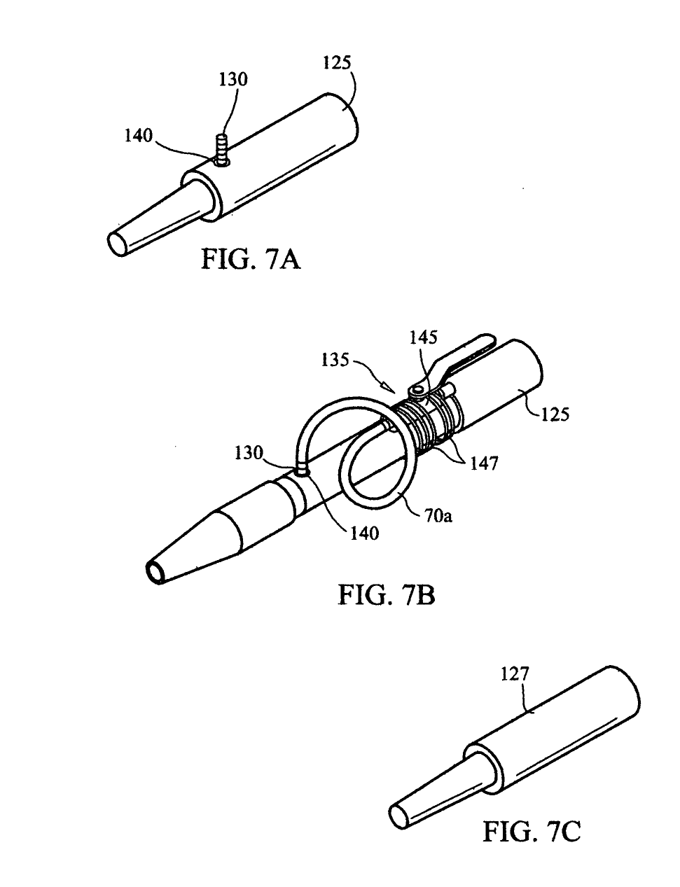

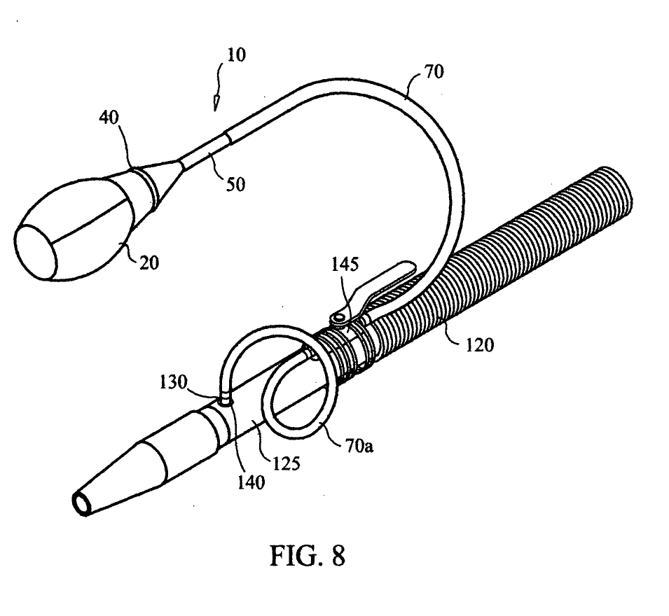

The discharge tube 125 is shown separately in FIG. 7A, with a coupling port 130 for receiving the flexible conduit 70. A discharge tube 125 is shown in FIG. 7B, with an alternate coupling port assembly 135. The alternate coupling port assembly 135 is provided with a valve 145 for restricting or closing the communication between the duster 10 and the air flow inside the blower hose assembly. It is intended that a user may operate the duster 10 in conjunction with the valve 145 to incrementally control the density of pest control particulate entrained in the air flow of the blower means, as shown in FIG. 8. The model 107-701 nc valve manufactured by B&K Industries Inc. or Elk Grove Village, Ill. is preferred for the valve 145 of the present invention. As shown in FIG. 7B, the alternate coupling port assembly 135 includes a valve 145 mounted on the discharge tube 125 by flexible plastic ties 147, of conventional design. The flexible conduit 70 may be connected in fluid communication with the valve 145 and the valve 145 may be connected, in fluid communication with the coupling port 130 by a valve flexible conduit 70a, which may be formed of plastic tubing like the flexible conduit 70. The B& K Industries Inc. valve is provided with tapered inlet and outlet for quickly connecting plastic tubing in frictional engagement, without the necessity of turning a threaded fitting to achieve a secure connection. It will be appreciated that an integral coupling port and valve may be incorporated into the apparatus as an alternate embodiment of the present invention.

The vacuum cleaner 110 may also be operated in a vacuum mode, according to conventional practice, by connecting the blower hose assembly for vacuum operation. The vacuum cleaner 110, of the present invention, configured in the vacuum mode, may be used as a conventional vacuum cleaner to collect debris. The necessity of carrying an additional piece of equipment to a work site, is avoided. In order to allow operation in the vacuum mode without the partial obstruction within the blower hose assembly presented by the inner nut and the inwardly protruding portion of the coupling port 130, a vacuuming tube 127, shown in FIG. 7C, is preferably provided as an additional interchangeable tail piece. The vacuuming tube 127 is preferably a conventional vacuum cleaner hose attachment. In certain pest treatment applications, bees may be eliminated without the use of chemicals by positioning a vacuum machine with an inlet to a vacuum hose proximate to the entryway of a beehive or bee nest, to collect the bees in the vacuum machine. The vacuum cleaner 110 of the present invention, may be used, in the vacuum mode, with the vacuuming tube 127 installed, to perform this method of treatment. Again, this operation may be performed, with the vacuum cleaner 110 of the present invention, without the necessity for an additional machine.

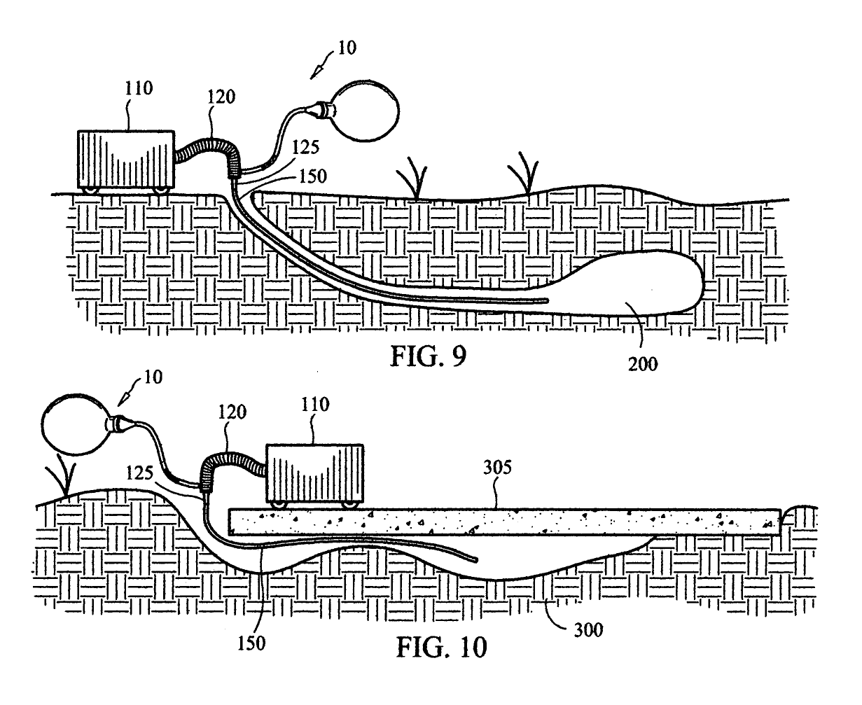

The duster 10 of the present invention is useful for delivering controlled quantities of pest control particulate to inaccessible areas, where contact with humans and pets is unlikely. The present invention configured with the duster 10 used to entrain particulate in the air flow of the vacuum cleaner hose 120 may be used to apply particulate in a relatively large space, such as a building attic and may also be used with a long flexible hose extender 150 to deliver pest control particulate, such as tracking powder, deep into the burrow of a pest, for direct application to the nesting area. A six foot length of flexible tubing is a suitable hose extender 150 and is particularly effective for delivering pest control particulate into a rat burrow 200. As shown in FIG. 9, the hose extender 150 is attached to a discharge tube 125. The same configuration of the present invention is effective for delivering pest control particulate to a pocket 300 beneath a concrete slab 305, as illustrated in FIG. 10. Pest control particulate may include pesticide, insecticide or desiccant. A desiccant powder may be used to eliminate moisture in inaccessible areas to prevent the breeding and growth of insects which require a wet environment.

The high speed passage of the pest control particulate through the vacuum cleaner hose 120 causes the particulate to acquire a static electric charge. The static charge collected on the particulate is an added advantage of the present invention because certain pest control particulates cling to surfaces when a static charge is present. The treatment of bed bugs is a particular example of an application which illustrates the benefit of charged particles.

Pesticides may comprise insecticides for insects and rodenticides for rodents. Both types of pesticide may be broadcast by the apparatus of the present invention. The application of rodenticide is to be commercially known as a Surgical Strike because the tracking powder may be deposited directly into the rodent nest, killing all occupants within ten days and preventing the reestablishment of a new nest for at least sixty days. It is recommended that a re-application be made at sixty day intervals to prevent a new infestation. The process of the present invention eliminates the need for bait in accessible boxes and dramatically reduces the chance of humans or non-targeted species coming into contact with pesticide.

Having fully described the present invention, it will be appreciated that minor variations may be incorporated without departing from the scope of the invention as disclosed and claimed herein.

I claim:

1. A process for applying pest control particulate comprising the steps of:
providing a duster having operable pneumatic dispersion means and a flexible conduit;
said pneumatic dispersion means having an inside space and an orifice communicating with said inside space;
said flexible conduit having a proximal end and a distal end;
charging said inside space with pest control particulate;
attaching said proximal end to said pneumatic dispersion means in communication with said orifice;
providing rigid nozzle means fitted to said distal end;
training said nozzle means toward a preselected target area by insertion into a wall void, a burrow, or a subterranean pocket;
adjusting the density of particulate application by orienting said pneumatic dispersion means to a preselected attitude; and
operating said pneumatic dispersion means to apply said particulate to said target area.

2. The process of claim 1 wherein pneumatic dispersion means comprises a flexible and resilient bulb reservoir manually operable by squeezing; and
said rigid nozzle means comprises a tube formed of material selected from the group of plastic, and metal.

3. The process of claim 1, wherein said flexible conduit is formed of material selected from the group of plastic and rubber.

4. A process for high speed application of pest control particulate comprising the steps of:
providing a duster having operable pneumatic dispersion means and a flexible conduit;
said pneumatic dispersion means having an inside space and an orifice communicating with said inside space;
said flexible conduit having a proximal end and a distal end;
charging said inside space with pest control particulate;
attaching said proximal end to said pneumatic dispersion means in communication with said orifice;
providing a blower means and a blower hose assembly;
said blower hose assembly having a proximal end and a distal end;
said distal end of said blower hose assembly having a tail piece;
connecting said proximal end of said blower hose assembly to said blower means for directing a high speed air flow through said blower hose assembly and outward from said tail piece;
providing a coupling port communicating with said high speed air flow through said blower hose assembly;
providing coupling means on said distal end of said flexible conduit for connecting said flexible conduit to said coupling port in communication with said high speed air flow;
connecting said flexible conduit to said coupling;
training said tail piece toward a preselected target area;
operating said blower means, adjusting the density of particulate application by orienting said pneumatic dispersion means to a preselected attitude, and operating said pneumatic dispersion means to entrain said particulate in said high speed air flow toward said target area.

5. The process of claim 4 wherein, pneumatic dispersion means comprises a flexible and resilient bulb reservoir manually operable by squeezing.

6. The process of claim 4 wherein, said flexible conduit is formed of material selected from the group of plastic and rubber.

7. The process of claim 4 further including, following the step of connecting said flexible conduit to said coupling, the additional steps of
providing a flexible hose extension;
attaching said hose extension to said tail piece, opposite said blower hose assembly, in communication with said high speed air flow;
training a length of said hose extension toward a preselected target area by insertion into a wall void, a burrow, or subterranean pocket.

8. The process of claim 4 wherein, following the step of adjusting the density of particulate application by orienting said pneumatic dispersion means to a preselected attitude, further including the step of repeatedly operating said pneumatic dispersion means to move a particularly desired measured quantity of particulate into said flexible conduit.

9. An apparatus for high speed application of pest control particulate comprising:
a duster, blower means, and a blower hose assembly;
said duster including pneumatic dispersion means having an inside space charged with pest control particulate, and a flexible conduit;
said pneumatic dispersion means having an orifice communicating with said inside space said flexible conduit having a distal end and a proximal end;
said flexible conduit being attached to said pneumatic dispersion means with said proximal end in communication with said orifice;
said blower hose assembly having a proximal end and a distal end;
said distal end of said blower hose assembly having a tail piece;
said proximal end of said blower hose assembly being operably connected to said blower means for directing a high speed air flow through said blower hose assembly and outward from said tail piece;
said blower hose assembly having a coupling port communicating with said high speed air flow;
said distal end of said flexible conduit having coupling means for connecting said flexible conduit to said coupling port in communication with said high speed air flow;
whereby said tail piece may be trained toward a preselected target area by insertion into a wall void, a building attic, a burrow, or subterranean pocket, said blower means may be operated, and said pneumatic dispersion means may be simultaneously oriented to a preselected attitude to adjust the density of particulate application, for operating said pneumatic dispersion means to entrain said particulate in said high speed air flow toward said target area.

10. The apparatus of claim 9, wherein, said pneumatic dispersion means comprises a flexible and resilient bulb reservoir manually operable by squeezing.

11. The apparatus of claim 9, wherein, said flexible conduit is formed of material selected from the group of plastic and rubber.
